(19) United States
(12) Patent Application Publication
(10) Pub. No.: US 2008/0116229 A1
(43) Pub. Date: May 22, 2008

(54) Cometic Bottle Structure for Discharging Fixed Quantity of Highly Viscosity Cosmetics

(76) Inventor: Sung Il Kang, Seoul (KR)

Correspondence Address: KOPPEL;31255 CEDAR VALLEY DRIVE, SUITE 302, WESTLAKE VILLAGE, CA, 913624031, US

(21) Appl. No.: 11/662,695

(22) PCT Filed: Sep. 2, 2005
(86) PCT No.: PCT/KR05/02922

§ 371 Date: Mar. 13, 2007

(30) Foreign Application Priority Data
Sep. 24, 2004 (KR) 20-2004-9927685
Apr. 7, 2005 (KR) 20-2--5-0009489
Apr. 8, 2005 (KR) 20--2005-0009702

(51) Int. Cl. G01F 11/00; B67D 5/52

(52) U.S. Cl. 222/390; 222/137; 222/257

(57) ABSTRACT

The structure of a cosmetics container capable of discharging content in a container main body at a constant amount is provided. The structure of the cosmetics container includes a cosmetics accommodating compartment; a pumping means provided in the cosmetics accommodating compartment and having a moving valve, which is operated by a button and has a content inlet switched to open by a ring-shaped packing; a screw element rotated by the pumping means; a latched gear for blocking the screw element from being rotated in reverse; and a piston for pressing the content out of the main body as it is elevated by the rotation of the screw element.

### TECHNICAL FIELD

The present invention relates to a structure of a cosmetics container capable of discharging highly viscosity content by a constant amount, more particularly, to a structure of a cosmetics container that has accommodating compartment for one or more kinds highly viscosity contents, a piston provided in the area of the accommodating compartment to press the content out at a constant amount as it moves upward along a screw axis and a pumping means for discharging the content outside, thereby prevents the content from deterioration due to contact with the air.

### BACKGROUND ART

In general, a highly viscosity cosmetics such as a nutrition cream, an eye-cream, a gel-type foundation, etc. must be kept in a circular container before served in use. When it is used, the content of the container is applied with fingers, with a cover opened. Accordingly, in this conventional container, it is afraid not only that availability of the content is shorten by frequent exposes of the surface of the highly viscosity content to the air because the cover need to be opened when used but also that the content is deteriorated by contact with contaminated fingers because user touches the contents with them when applying. Further, the content tends to be wasted unnecessarily by impossibility in controlling an amount to use because user applies the content by fingers.

On the other hand, there are some kinds of cosmetics such that they should be mixed when in use with other cosmetics to enhance their effectiveness. Because their effectiveness is reduced due to chemical reactions from each other if they were in mix prior to their usage. So, they are to be disposed when in use while being kept in separate containers when not in use. Thus, this is not comfortable.

One of things to overcome those problems was disclosed in the Korean registered utility patent No. 370575 filed by the present applicant. The conventional container comprises a button which is supported elastically by a spring at the upper portion of a container main body and has an outlet for discharging the content in its center; a pumping means which is operated by the button and has a moving valve whose content inlet can be switched to open by an end portion of a cylinder; a screw axis which can be rotated by an up-down movement of the button; and a piston which is elevated to press the content out of the container main body in accordance with the rotation of the screw axis. It was designed to solve such a problem that the content was deteriorated or wasted unnecessarily by discharging the content as much as a constant amount with the pumping means.

### DISCLOSURE OF INVENTION

### Technical Problem

This device has problems such that the content is prone to leak between the end portion of the cylinder and the moving valve, the pumping means becomes to be inoperable due to an influx of the leaked content into operational parts of the pumping means, etc. Further, separate containers are still needed for different cosmetics. Therefore, unfortunately, this device hardly solved problems in conventional container.

### Technical Solution

An object of the present invention is to provide a container that can prevent its content from being contacted with the air by discharging without opening a cover, from being deteriorated by discharging by a pumping means, not by a finger, when used and from being wasted by discharging at a constant amount with the pumping means.

Another object of the present invention is to provide a container that can eliminate a leakage of its content as an improvement of the device according to the Korean registered utility patent of No. 370575.

Still another object of the present invention is to provide a container that can discharge various kinds of highly viscosity contents simultaneously.

### Advantageous Effects

Objects of the present invention can be achieved by providing a highly viscosity cosmetics container, in which cosmetics accommodating compartments capable of containing one or more kinds of highly viscosity cosmetics respectively is formed, for discharging highly viscosity contents at a constant amount by operating respective piston provided in the bottom portion of each cosmetics accommodating compartment to be elevated upward by a screw axis and respective pumping means provided in the upper portion of the container main body to switch the content inlet of a moving valve to open by its ring-shaped packing simultaneously.

According to the present invention there is provided a structure of a cosmetics container capable of discharging content in a container main body 100 at a constant amount, the structure of the cosmetics container comprising:

a cosmetics accommodating compartment;

a pumping means provided in the cosmetics accommodating compartment and having a moving valve, which is operated by a button and has a content inlet switched to open by a ring-shaped packing;

a screw element rotated by the pumping means;

a latched gear for blocking the screw element from being rotated in reverse; and

a piston for pressing the content out of the container main body as it is elevated by the rotation of the screw element.

Additional aspects and/or advantages of the invention will be set forth in part in the description which follows and, in part, will be obvious from the description, or may be learned by practice of the invention.

### BRIEF DESCRIPTION OF THE DRAWINGS

The above and/or other features and advantages of the present invention will become more apparent by describing in detail exemplary embodiments thereof with reference to the attached drawings in which:

FIG. 1 shows a longitudinal sectional view of a cosmetics container according to the present invention;

FIG. 2 through 5 illustrate processes of a pumping means of the cosmetics container according to the present invention, respectively;

FIG. 6 shows sectional view of a latched gear adapted to the present invention;

FIG. 7 through 8 show a disassembled perspective view and an assembled perspective view of the latched gear adapted to the present invention, respectively;

FIG. 9 shows an assembled state of a piston of the cosmetics container according to the present invention;

FIG. 10 shows a sectional view along A-A′ line in FIG. 5;

FIG. 11 shows a disassembled perspective view of the piston of the cosmetics container according to the present invention;

FIG. 12 shows a disassembled perspective view of the pumping means of the cosmetics container according to the present invention;

FIG. 13 shows a perspective view of the pumping means of the cosmetics container according to the present invention;

FIG. 14 through 16 show pressing processes of the pumping means of the cosmetics container according to the present invention, respectively;

FIG. 17 through 19 shows restoring processes of the pumping means of the cosmetics container according to the present invention, respectively;

FIG. 20 shows a longitudinal sectional view of the cosmetics container according to another embodiment of the present invention;

FIG. 21 through 24 illustrate processes of a pumping means of the cosmetics container according to another embodiment of the present invention, respectively;

FIG. 25 show a sectional view along B-B′ line in FIG. 20;

FIG. 26 shows a disassembled perspective view of the piston of the cosmetics container according to another embodiment of the present invention;

FIG. 27 shows a disassembled perspective view of the pumping means of the cosmetics container according to another embodiment of the present invention;

FIG. 28 shows a perspective view of the pumping means of the cosmetics container according to another embodiment of the present invention;

FIG. 29 through 31 show pressing processes of the pumping means of the cosmetics container according to another embodiment of the present invention, respectively;

FIG. 32 through 34 show restoring processes of the pumping means of the cosmetics container according to another embodiment of the present invention, respectively;

FIG. 35 through FIG. 37 illustrate longitudinal sectional views of the cosmetics container according to still another embodiment of the present invention, respectively; and

FIG. 38 and FIG. 39 illustrate partial sectional views of a piston of the cosmetics container according to still another embodiment of the present invention, respectively.

### LIST OF NUMERALS TO MAIN PARTS OF THE DRAWINGS

100: container main body 106: content

108: cosmetics accommodating compartment 110: upper cover

120: button 122: outlet

124; spring 140: screw axis

150: piston 152: sealing rubber

154: piston nut 200: pumping means

210: elevating element 212: projection

220: rotating element 222: spiral groove

224: driving gear 230: screw element

232: driven gear 234: content moving hole

235: valve 236: latched gear

238: connecting gear 239: clamping gear

240: moving valve 242: content inlet

250: cylinder 252: ring-shaped packing

### MODE FOR THE INVENTION

Reference will now be made in detail to the embodiments of the present invention, examples of which are illustrated in the accompanying drawings, wherein like reference numerals refer to the like elements throughout. The embodiments are described below to explain the present invention by referring to the figures. For the sake of clarity and concision, technology related to the present invention that is not novel and is well known in the art to which the present invention pertains will not be described herein.

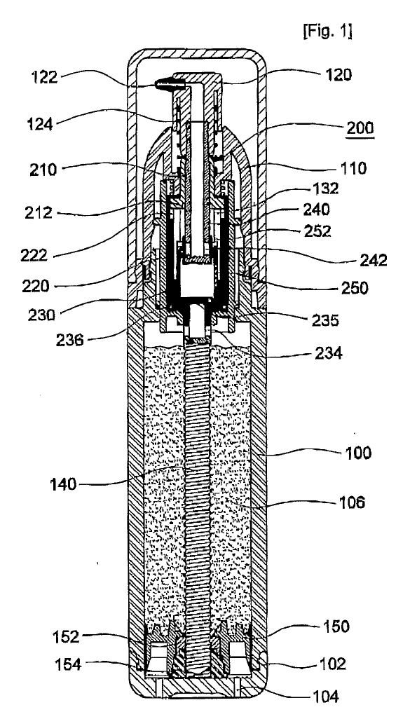

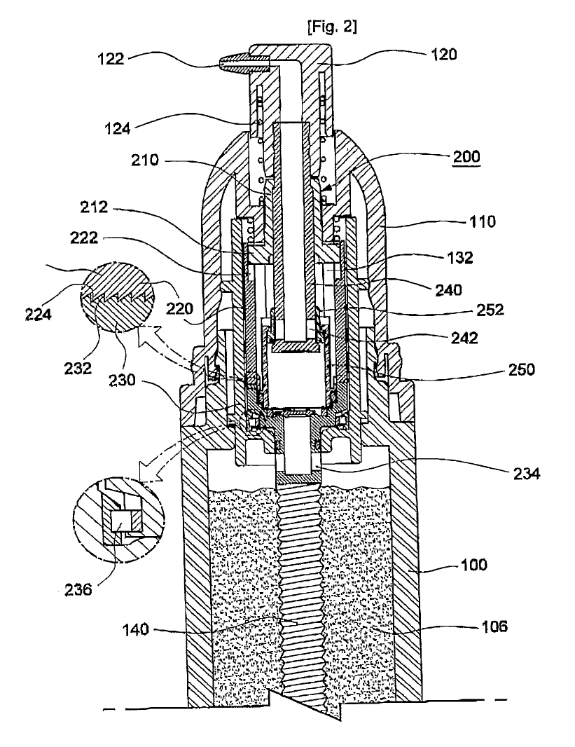

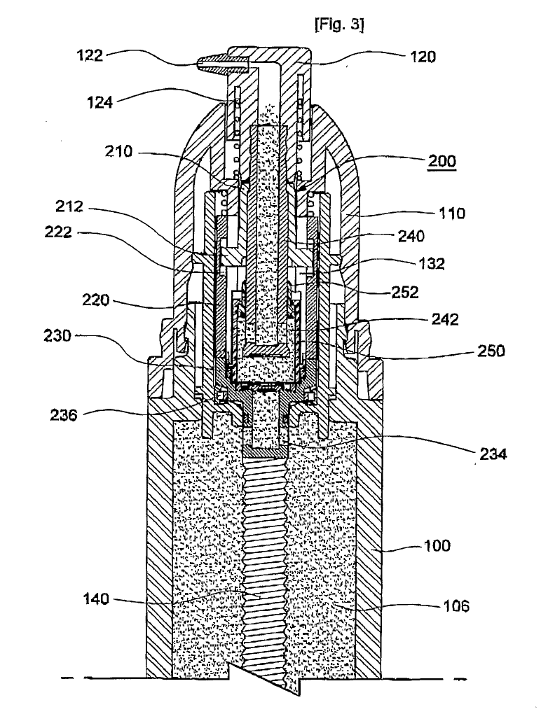

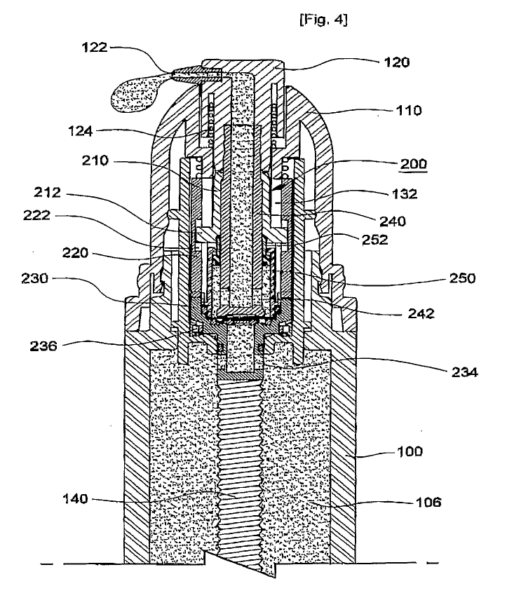

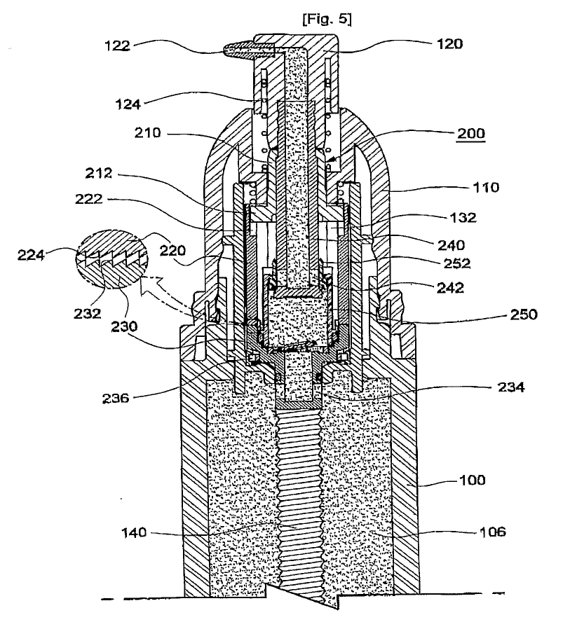

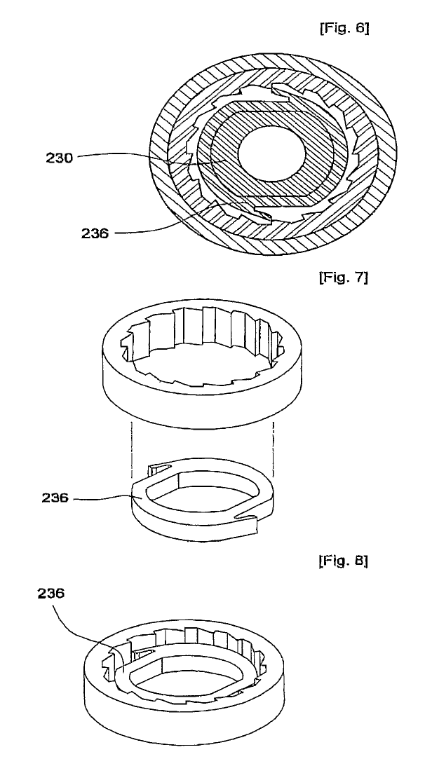

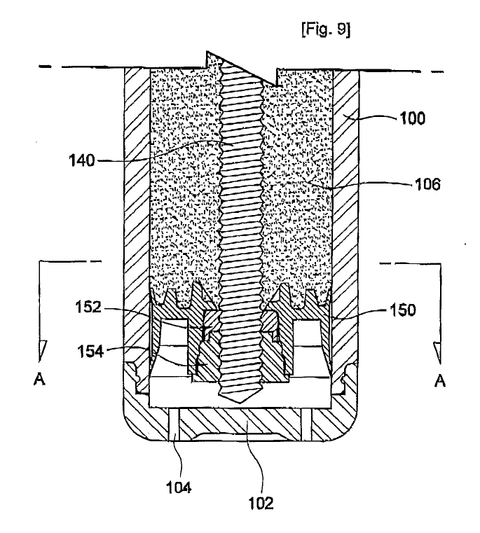

FIG. 1 shows a longitudinal sectional view of a cosmetics container according to the present invention; FIG. 2A through 2D illustrate processes of a pumping means of the cosmetics container according to the present invention, respectively; FIG. 3 shows sectional view of a latched gear 236 adapted to the present invention; FIG. 4A through 4D show a disassembled perspective view and an assembled perspective view of the latched gear 236 adapted to the present invention, respectively; FIG. 5 shows an assembled state of a piston 150 of the cosmetics container according to the present invention; FIG. 6 shows a sectional view along A-A′ line in FIG. 5; FIG. 7 shows a disassembled perspective view of the piston 150 of the cosmetics container according to the present invention; FIG. 8 shows a disassembled perspective view of the pumping means of the cosmetics container according to the present invention; FIG. 9 shows a perspective view of the pumping means of the cosmetics container according to the present invention;

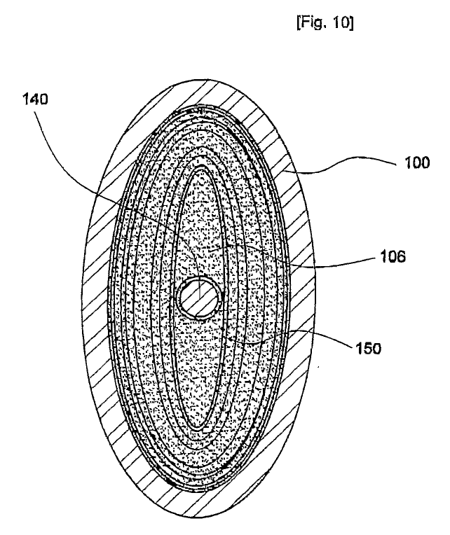

FIG. 10A through 10D show pressing processes of the pumping means of the cosmetics container according to the present invention, respectively; and FIG. 11A through 11D shows restoring processes of the pumping means of the cosmetics container according to the present invention, respectively.

Referring to FIG. 1 through 11, the cosmetics container of the present invention includes a container main body 100 in which a cosmetics accommodating compartment 108 capable of containing a high viscosity cosmetics such as a nutrition cream, an eye cream, gel-type foundation, etc., is formed and a container lit 102 is provided to the bottom of the container main body 100. A upper cover 110 is assembled to the top of the container main body 100, a button 120, which is supported elastically by a spring 124, is assembled to the center of the upper cover 110 in the shape of protrusion, and an outlet 122 for discharging a content 106 is formed in the center of the button 120.

Further, a pumping means 200, which is operated by the button 120, is provided inside of the upper cover 110. The pumping means 200 is operationally connected to the bottom portion of the button 120 so that it can be elevated along with the button 120. The button 120 and the pumping means 200 can be operated together since an elevating element 210 and the button 120 are inserted in sequence tightly by force into a moving valve 240. In addition, projection 212 is formed around the outer periphery in the bottom portion of the elevating element 210.

An incised section 132 is formed on the inside wall of the upper cover 110. The projection 212 of the elevating element 210 is inserted into the incised section 132 in a manner of penetration. A rotating element 220 having a spiral groove 222 on its inner periphery is inserted into the incised section 312 of inner wall of the upper cover 110 so that the projection 212 of the elevating element 210 is inserted into the spiral groove 222 of the rotating element 220. And, a driving gear 224 is provided in the bottom portion of the rotating element 220.

Meanwhile, a driven gear 232 selectively gear-connected to the driving gear 224 is provided at the top of a screw element 230. A screw axis 140 is formed in the bottom of the screw element 230 integrally. A content moving hole 234, which the content 106 is moved through, is formed on the top of the screw axis 140 and a valve 235 is provided inside of the top portion of the screw element 230 for stably discharging the content 106.

A content inlet 242 is formed on the outer periphery of the bottom portion of a moving value 240, which is inserted inside the elevating element 210, and a ring-shaped packing 252 is inserted to the end portion of the moving valve 240 so as to selectively switch the content inlet 242. Further, a cylinder 250 is assembled to the ring-shaped packing 252.

In addition, a piston 150 is screwed to the screw axis 140, which is integrally formed in the bottom portion of the screw element 230, for pressing the content 106 out of the container main body 100 while being elevated by a rotation of the screw axis 140

A sealing rubber 152 is inserted into the inside of the piston 150 so that sealing between the screw axis 140 and the piston 150 is maintained tightly. Further, a piston nut 154 is screwed to the lower end of the screw axis 140 so that the sealing rubber 152 is pressed to contact with the screw axis 140 tightly.

Meanwhile, since the piston 150 must be elevated without its rotation, a sectional shape of the container main body 100 and the piston 150 is not a circle but an ellipse so as to prevent the piston 150 from rotating. It can be understood that the piston 150 does not rotate but elevate if the section of the container main body 100 and the piston 150 is of any type for example, a triangle, rectangle, etc. except a circle.

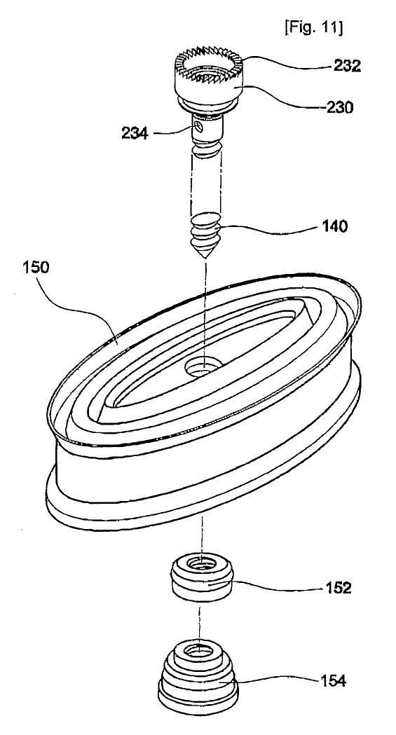

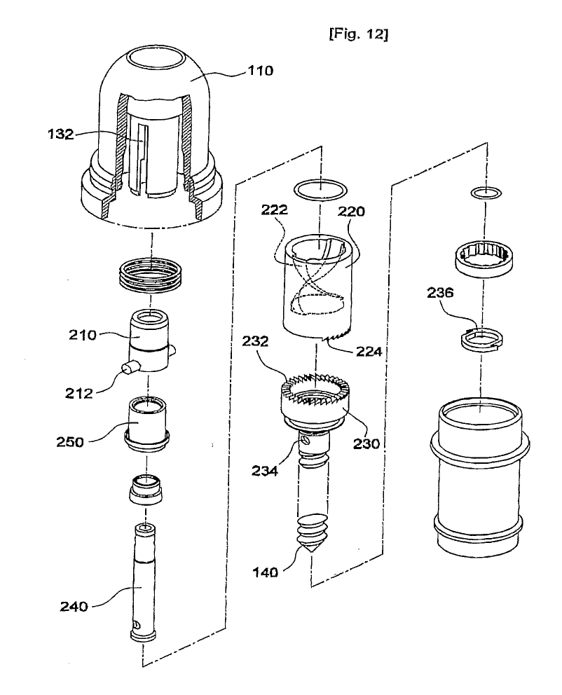

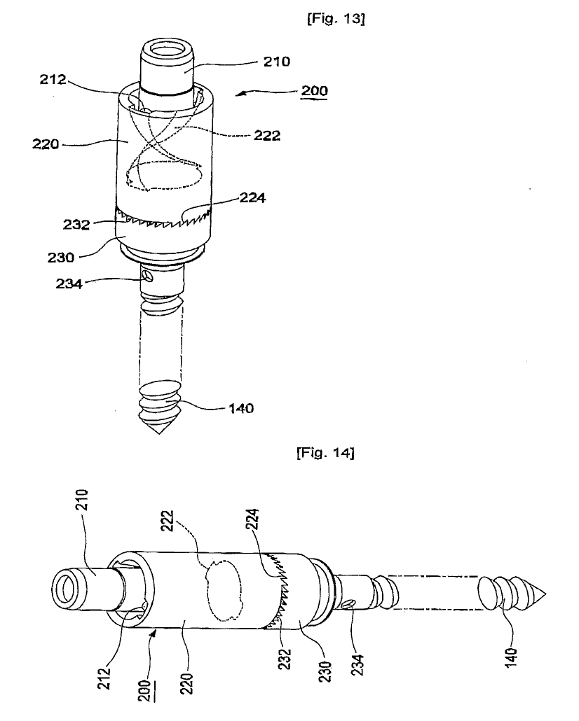

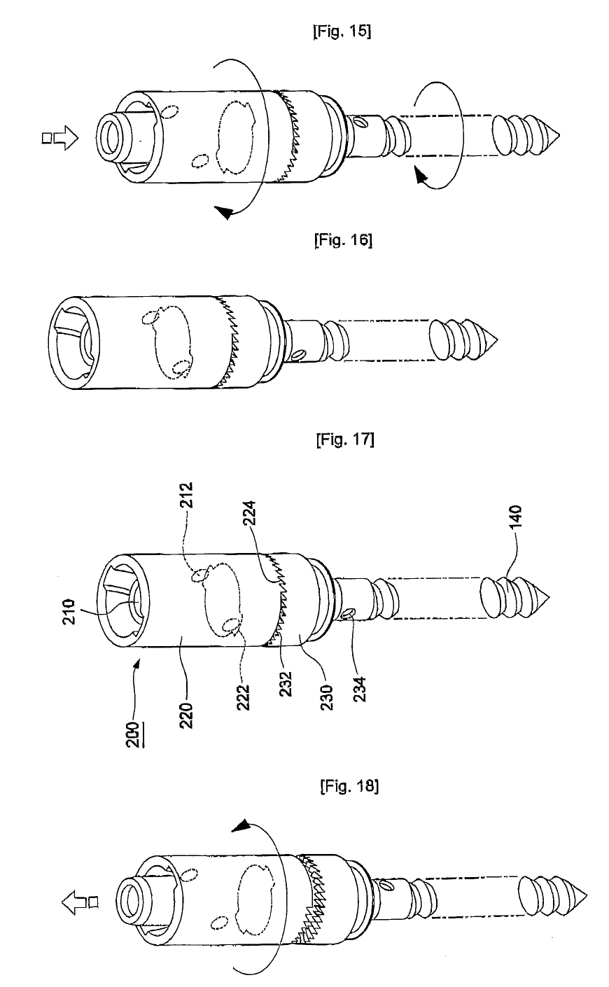

FIG. 12 shows a longitudinal sectional view of the cosmetics container according to another embodiment of the present invention; FIG. 13A through 13D illustrate processes of a pumping means of the cosmetics container according to another embodiment of the present invention, respectively; FIG. 14 show a sectional view along B-B′ line in FIG. 12; FIG. 15 shows a disassembled perspective view of the piston 150 of the cosmetics container according to another embodiment of the present invention; FIG. 16 shows a disassembled perspective view of the pumping means of the cosmetics container according to another embodiment of the present invention; FIG. 17 shows a perspective view of the pumping means of the cosmetics container according to another embodiment of the present invention;

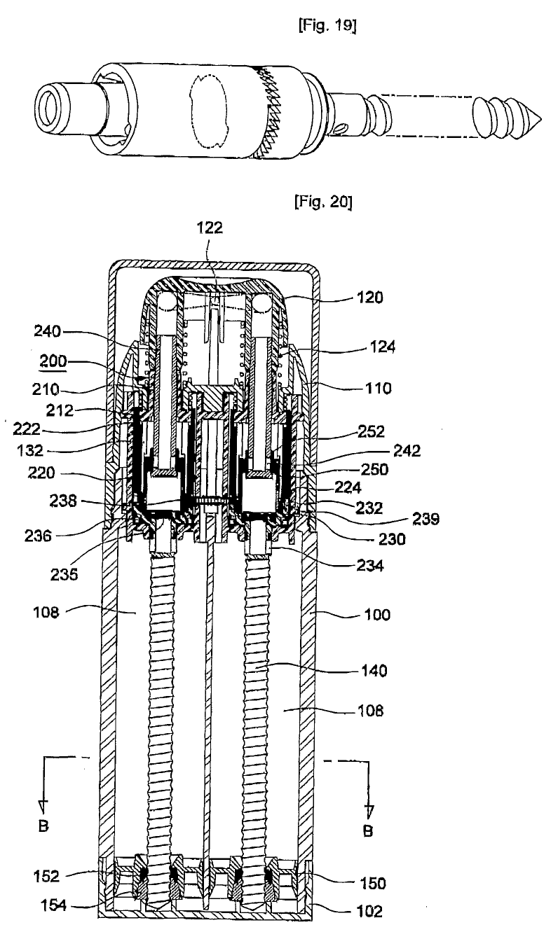

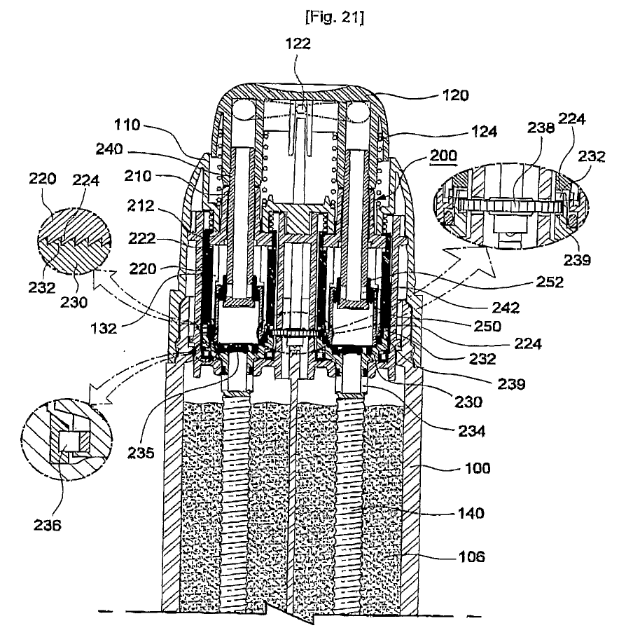

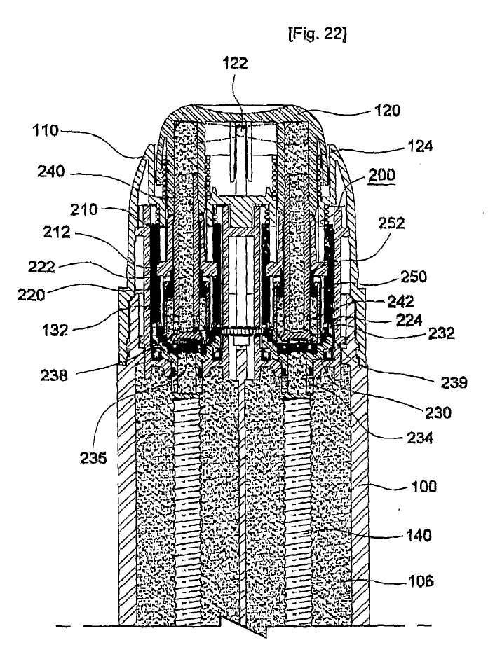

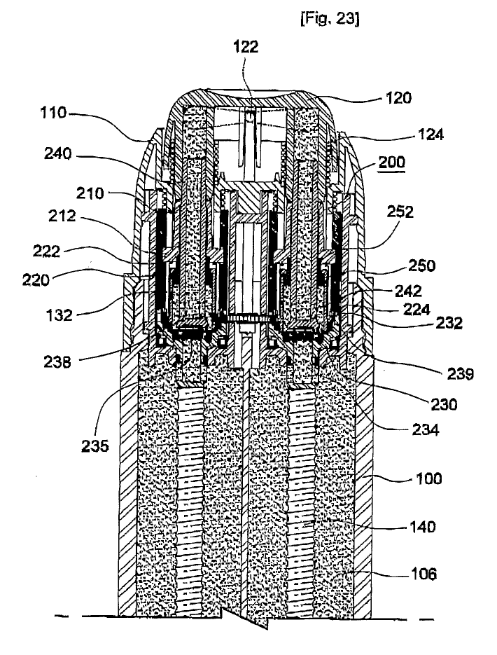

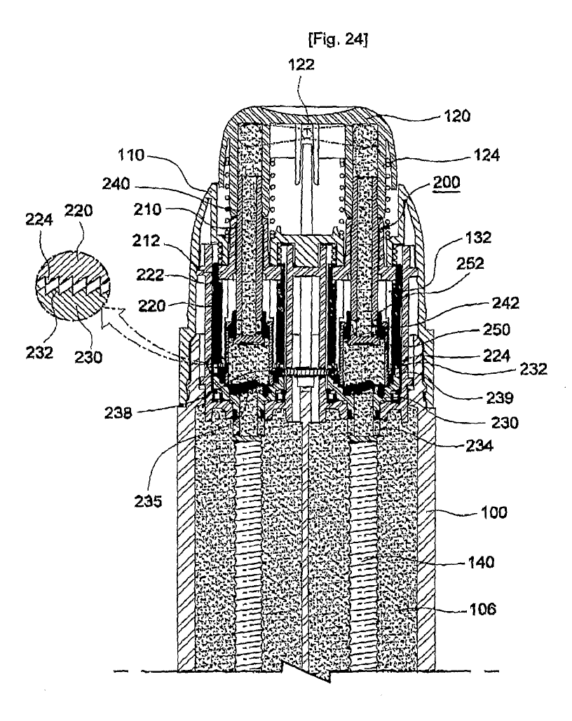

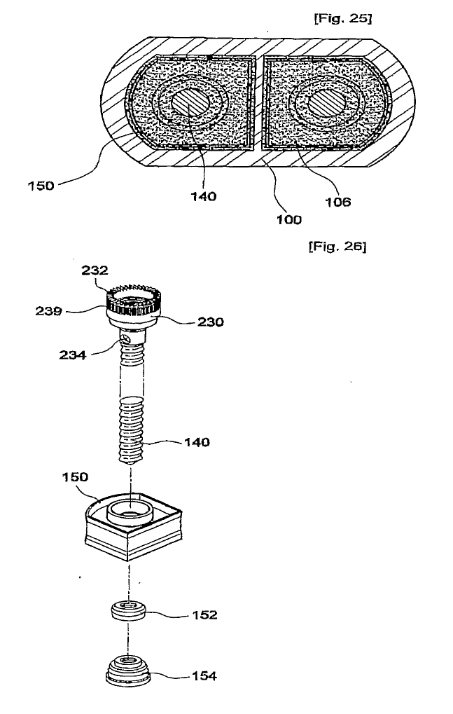

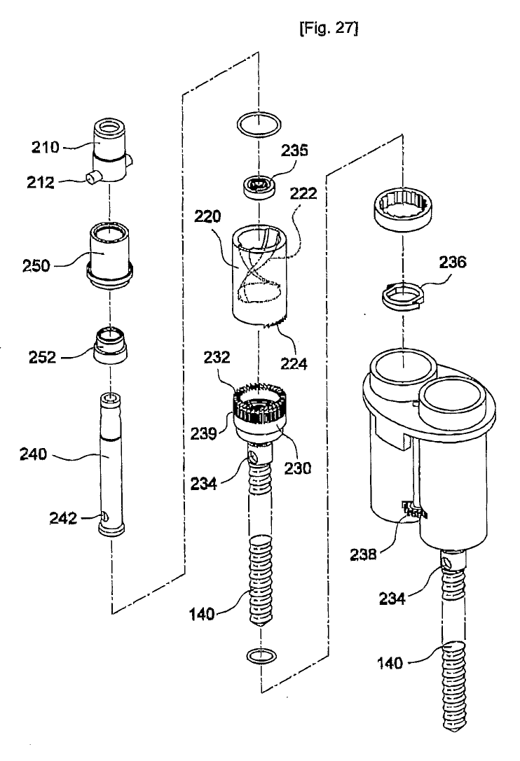

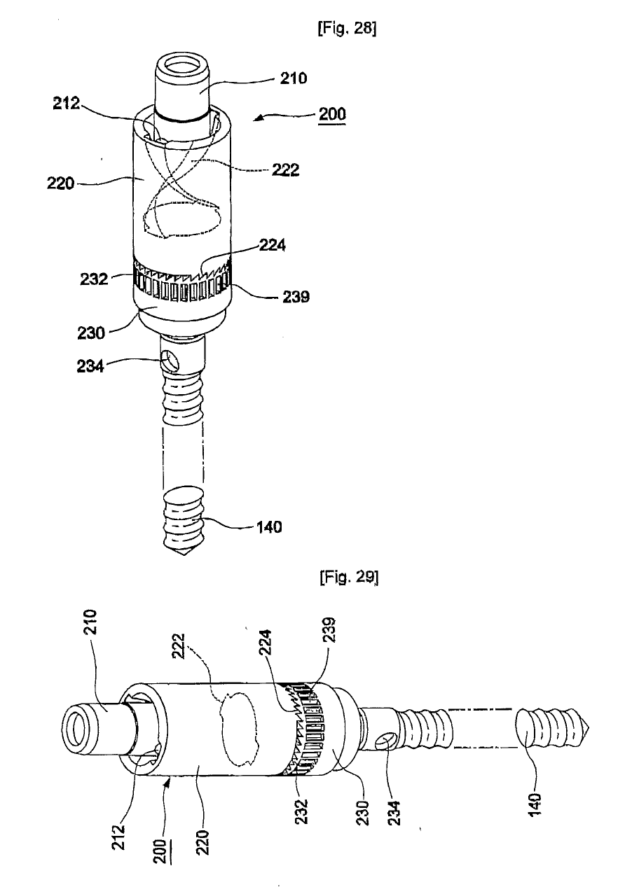

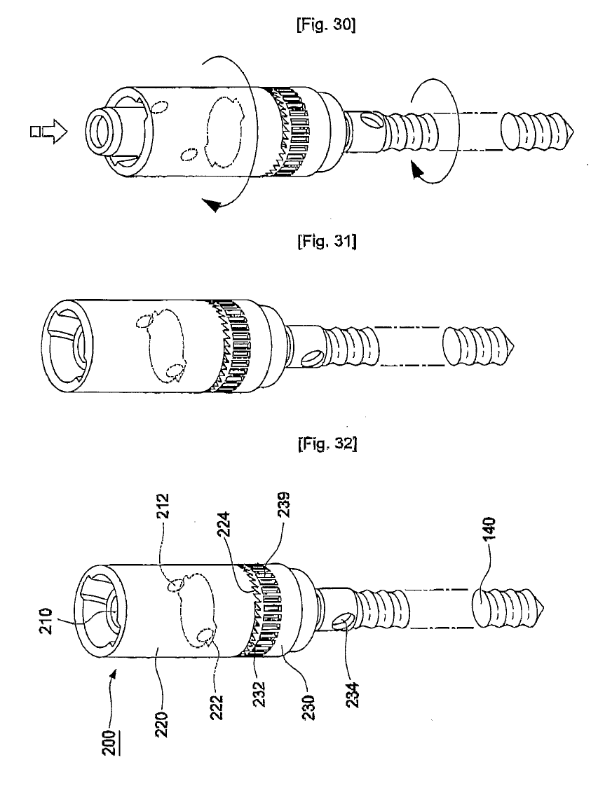

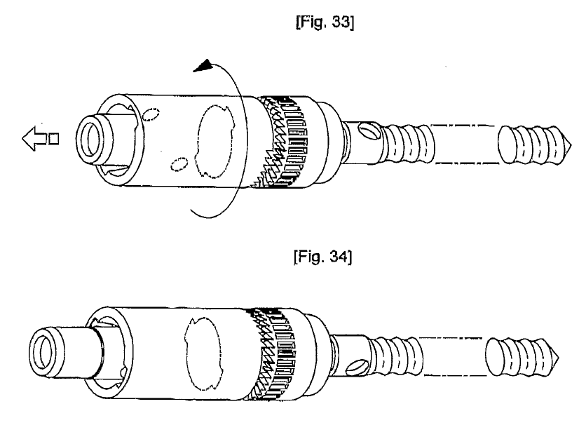

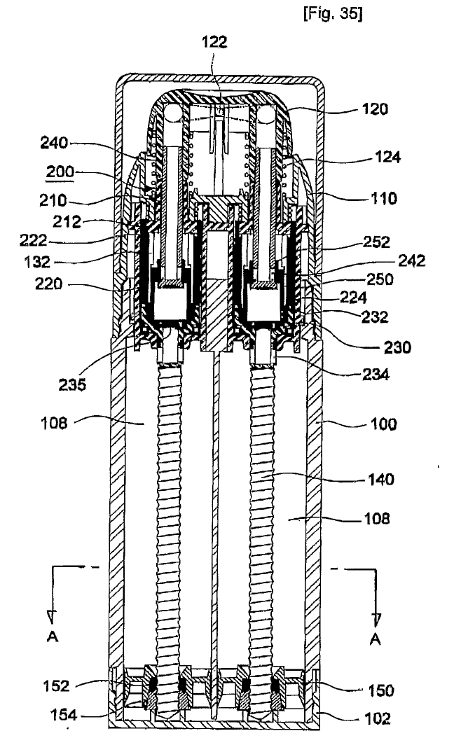

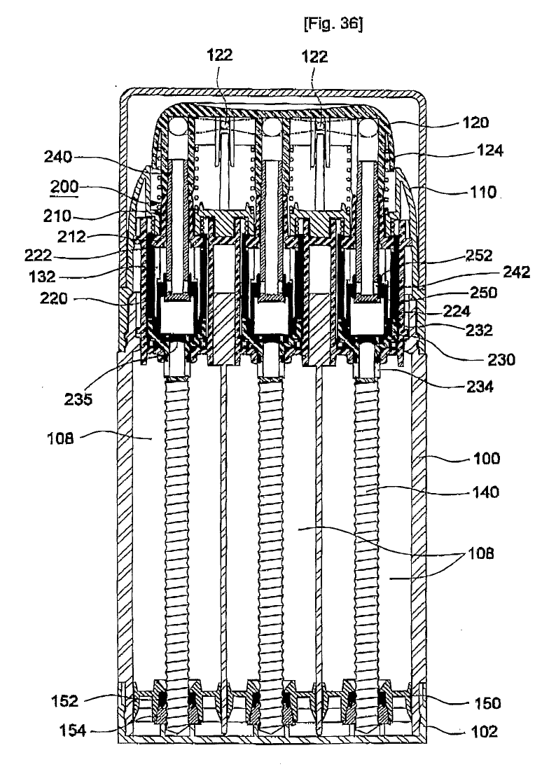

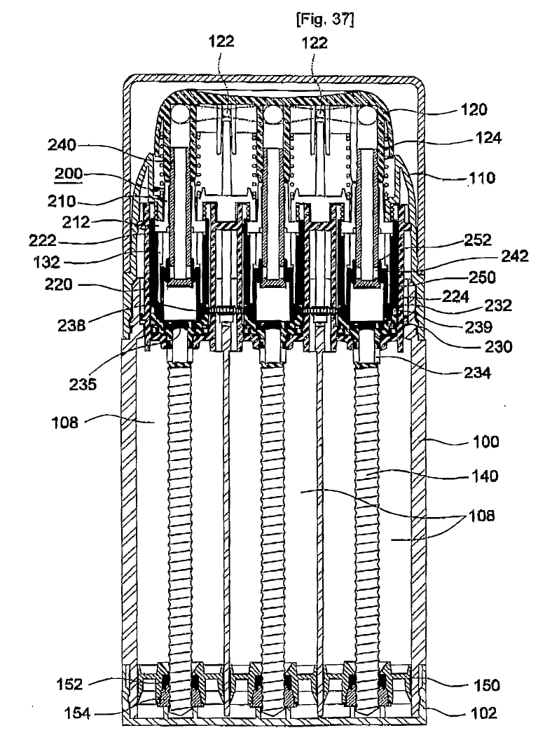

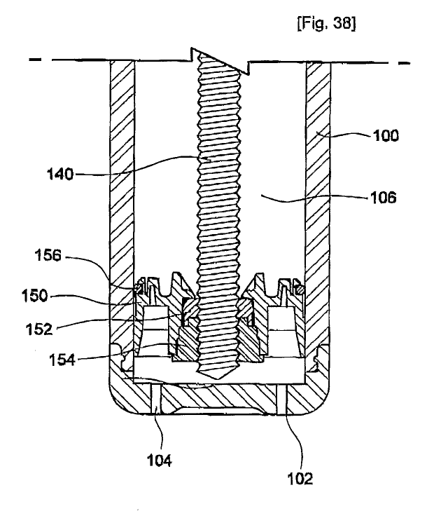

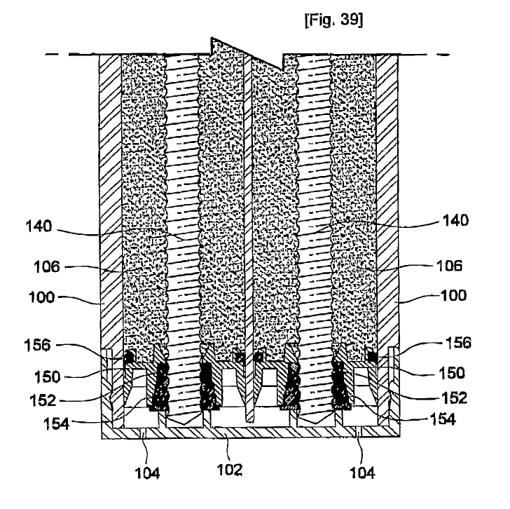

FIG. 18A through 18D show pressing processes of the pumping means of the cosmetics container according to another embodiment of the present invention, respectively; FIG. 19A through 19D show restoring processes of the pumping means of the cosmetics container according to another embodiment of the present invention, respectively; FIG. 20 through FIG. 22 illustrate longitudinal sectional views of the cosmetics container according to another embodiment of the present invention, respectively; and FIG. 23 and FIG. 24 illustrate partial sectional views of a piston 150 of the cosmetics container according to another embodiment of the present invention, respectively.

Referring to FIG. 12 through FIG. 19c, a cosmetics container according to another embodiment of the present invention is formed so that various kinds of content 106 can be discharged simultaneously. Thus, it is naturally needed that contents 106 in all the accommodating compartments 108 are exhausted simultaneously by relating all the respective pumping means 200 together in a manner of discharging respective content 106 at the same amount, so that any content 106 in all the cosmetics accommodating compartments 108 is not remained.

According to another embodiment of the present invention, to relate two pumping means 200 together, clamping gears 239 are formed on the each side of the top portions of the screw elements 230 respectively and a connecting gear 238 is provided to gear two pumping means 200 together.

The operation of the cosmetics container of another embodiment of the present invention will be described fully as bellow.

When the cosmetics container is not in use, the content 106 in the container main body 100 is isolated from outer circumstances because the ring-shaped packing 252 blocks the content inlet 242 of the moving valve 240. As the button 120 is pressed to discharge the content 106, the button 120 is moved downward while pressing the spring 124. The moving valve 240 tightly inserted into the button 120 and the elevating element 210 tightly inserted into the moving valve 240 are moved downward along with the button 120.

As the elevating element 210 is moved downward, the projection 212, which is formed on the outer periphery of the elevating element 210 moves only in a linear movement within the longitudinal length of the incised section 132. Because that the spiral groove 222, where the projection 212 of the rotating element 220 is inserted into, is slanted, the linear movement of the projection 212 of the elevating element 210 receives obstruction. When the elevating element 210 is pressed more, the rotating element 220 becomes to rotate because the projection 212 goes through downward while pressing the wall of the spiral groove 222 aslant.

Because the driven gear 232, gear-connected to a driving gear 224 of the rotating element 220, rotates along with the rotating element 220, and thereby the screw element 230 and the screw axis 140 integrally formed to the driven gear 232 rotates as the rotating element 220 rotates, a rotating force is delivered to the piston nut 154 screwed to the bottom portion of the screw axis 140.

Because the piston 150 is formed to have such a shape that it cannot be rotated, the piston 150 cannot rotate but move upward along with the piston nut 154 as the screw axis 140 rotates,

As the piston 150 moves upward, the content 106 in the container main body 100 is pressed to move through the content moving hole 234 provided in the upper portion of the screw element 230.

Meanwhile, for the moving valve 240 provided in the center of the button 120 is moved down and a volume of the cylinder 250 becomes decreased as the button 120 moves downward, pressure in the cylinder 250 becomes increased.

If pressure in the cylinder 250 increases, only the moving valve 240 except the ring-shaped packing 252 can be moved down due to the increased pressure in the cylinder 250. Thus, the content inlet 242 provided on the periphery of the end portion of the moving valve 240 is switched to the opening state from the closed state as shown in FIG. 2a and FIG. 13a, so that the content 106 in the cylinder 250 is discharged through the content inlet 242. If the button 120 is pressed more deeply from that state, the content 106 is discharged outside through an outlet 122 as shown in FIGS. 2C and 13C.

Further, because the air is moved through the air hole 104 provided in the bottom potion the container main body 100 when the piston 150 moves upward, thereby the piston 150 can moves smoothly.

Because the moving valve 240 is moved upward by the restoring force of the spring 124 if the button 120 is released after discharging the content 106, the content inlet 242 turned to close by the ring-shaped packing 252.

At this time, because the spiral groove 222 of the rotating element 220, which the projection 212 of the elevating element 210 is inserted into, hinders the elevation of the projection 212 in linear movement, the gear connection between the driving gear 224 of the rotating element 220 and the driven gear 232 of the screw element 230 is temporally disconnected while the rotating element 220 is lifted slightly upwardly by friction force between the projection 212 and the side wall of the spiral groove 222. Accordingly, the rotating element 220 rotates in reverse compared to the time when the button 120 is pressed and goes back to its initial position as shown FIG. 2d and FIG. 13d.

The operation of the pumping means 200 is described in more detail in reference with FIGS. 10, 11, 18 and 19.

If the elevating element 210 is pressed in the state as shown in FIGS. 10a and 18a, the projection 212 of the elevating element 210 goes down in a linear movement within the longitudinal length of the incised section 132 of the upper cover 110 while the rotating element 220, in which the spiral groove 222 is formed, rotates clockwise. Because the driving gear 224 and the driven gear 232 are gear-connected, the screw element 230 and the screw axis 140 rotate along with the rotating element 220.

Meanwhile, if the elevating element 210 is released from fully pressed state as shown in FIGS. 11a and 19a, the elevating element 210 goes upward by the force of the spring 124. However, the elevating element 210 cannot help to move in a linear movement since the movement of the projection 212 of the elevating element 210 is limited within the longitudinal length of the incised section 132 of the upper cover 110, and thereby the gear connection between the driving gear 224 of the rotating element 220 and the driven gear 232 of the screw element 230 is temporally released since the rotating element 220 is lifted up slightly by friction force between the spiral groove 222 and the projection 212 as shown in FIGS. 11b and 19b. Accordingly, the rotating element 220 rotates in reverse with ease to go back to its initial position as shown in FIGS. 11c and 19c.

At this time, the screw axis 140 is blocked from rotating in reverse by the latched gear 236 assembled to the screw element 230 as shown in FIGS. 3, 4a and 4b.

In addition, a piston ring 156 may be further comprised to increase a sealing capacity of the piston 150 as shown in FIGS. 23 and 24. By the piston ring 156, the piston 150 can be moved more smoothly as well as the sealing capacity can be increased.

Though an embodiment of a cosmetics container, which has one or two cosmetics accommodating compartments 108 and respective pumping means 200 is provided to the respective cosmetics accommodating compartment 108, is described above, it must be appreciate that the present invention cannot be limited to such a container that can discharge one or two kinds of cosmetic. For example, It is possible to discharge three highly viscosity cosmetics by providing 3 cosmetics accommodating compartments 108 and mounting respective pumping means 200 in the area of respective cosmetics accommodating compartment 108 and further to discharge three kinds of contents 106 at the same amount by providing a clamping gear 239 to the upper side of each screw element 230 and a connecting gear 238 among clamping gears 239 so that any content 106 of the cosmetics accommodating compartments 108 is remained.

By such a manner, a plurality of the accommodating compartments 108 can be configured, of course.

FIG. 20 shows a cosmetics container according to still another embodiment of the present invention that has no clamping gear 239 and connecting gear 238 to reduce the cost in manufacturing.

### INDUSTRIAL APPLICABILITY

While the present invention has been particularly shown and described with reference to an exemplary embodiment thereof, it will be understood by those of ordinary skill in the art that various changes in form and details may be made therein without departing from the spirit and scope of the present invention as defined by the following claims and their equivalents.

1. A structure of a cosmetics container capable of discharging content 106 in a container main body 100 at a constant amount, the structure of the cosmetics container comprising:
a cosmetics accommodating compartment 108;
a pumping means 200 provided in the cosmetics accommodating compartment 108 and having a moving valve 240, which is operated by a button 120 and has a content inlet 242 switched to open by a ring-shaped packing 252;
a screw element 230 rotated by the pumping means 200;
a latched gear 236 for blocking the screw element 230 from being rotated in reverse; and
a piston 150 for pressing the content 106 out of the container main body 100 as it is elevated by the rotation of the screw element 230.
The apparatus of claim 1, wherein a plurality of cosmetics accommodating compartments 108 are provided.
The apparatus of claim 2, further comprising:
clamping gears 239 provided to the screw element 230, respectively; and
a connecting gear 238 for connecting the clamping gears 239 each other, whereby, the contents 106 of the cosmetics accommodating compartments 108 are discharged at the same amount.
The apparatus of claim 1, the pumping means comprising:
an elevating element 210 elevated along with the button 120 and having a projection 212 formed on an its outer surface;
a upper cover 110 inserted on the outside of the elevating element 210 and having an incised section 132 on its inside wall so that the projection 212 of the elevating element 210 can be inserted in a manner of penetration;
a rotating element 210 to which the elevating element 210 is inserted and having a spiral groove 222 on its internal periphery, to which the projection 212 of the elevating element 210 is inserted, and a driving gear 224 in its bottom portion;
a screw element 230 having a driven gear 232, which is gear-connected to the driving gear 224 selectively, on its upper portion, a screw axis 140 in its bottom portion and a content 106 introducing hole 234 thereto;
a moving valve 240 inserted to the inside of the elevating element 210 and having the content inlet 242 on its outer periphery;
a ring-shaped packing for switching to open the content inlet 242 of the moving valve 240; and
a cylinder 250 inserted into the bottom portion of the screw element 230 tightly.
The apparatus of claim 1, the piston 150 further comprising:
a piston ring 156 so that sealing capacity of the piston 150 is increased and movement of the piston 150 can be smoother as well.
The apparatus of claim 1, further comprising:
a valve 235 provided to the upper inner portion of the screw element 230.
